(19) United States
(12) Patent Application Publication
(10) Pub. No.: US 2015/0105872 A1
(43) Pub. Date: Apr. 16, 2015

(54) RELIABILITY CALCULATION DEVICE AND METHOD

(71) Applicants: Hideyuki Kobayashi, Tokyo (JP); Masahiro Watanabe, Tokyo (JP)

(72) Inventors: Hideyuki Kobayashi, Tokyo (JP); Masahiro Watanabe, Tokyo (JP)

(73) Assignee: HITACHI, LTD., Tokyo (JP)

(21) Appl. No.: 14/398,479

(22) PCT Filed: May 25, 2012
(86) PCT No.: PCT/JP2012/063491

§ 371 Date: Nov. 28, 2014

(51) Int. Cl. G05B 9/02; H04L 29/08

(52) U.S. Cl. CPC G05B 9/02; H04L 67/10
USPC 700/79

(57) ABSTRACT

A technique for calculating the reliability of a control instruction with high precision is provided. A reliability calculation device that calculates reliability of a control instruction given to a control device which executes a control according to the control instruction includes an instruction acquisition unit, an information acquisition unit, and a reliability calculation unit. The instruction acquisition unit acquires the control instruction to the control device. The information acquisition unit acquires relevant information relevant to the control which is executed by the control device. The reliability calculation unit calculates the reliability of a target control instruction which is the control instruction to be calculated in reliability, on the basis of the relevant information relevant to the control of the target control instruction, which is acquired by the information acquisition unit in association with the target control instruction to be acquired by the instruction acquisition unit, and the target control instruction.

### TECHNICAL FIELD

The present invention relates to a technique for determining the reliability of a control instruction that is transmitted via a communication path.

### BACKGROUND ART

In a lot of industrial systems including a power system, a control instruction is given to respective control devices from a central management system through a communication network. The control instruction of this type has the potential to be rewritten by an influence of a communication noise, or intentionally rewritten. When the control device executes control according to such an abnormal control instruction, there arises such a problem that the stability of the system is lost. For that reason, in the industrial system, the ensuring of security of the control instruction given to the control device from the central management system through a communication network has been strongly demanded.

Under the above background, PTL 1 discloses a technique for determining whether operation accepted by a computer is a fraudulent manipulation, or not. In the technique of PTL 1, the computer learns a tendency of past operations to create a profile in advance, and the computer determines whether the operation is an action that deviates from the profile, or not, when accepting a new operation, and determines that the operation is the fraudulent manipulation if the operation is a specific action.

### CITATION LIST

### Patent Literature

PTL 1: Japanese Patent No. 4383413

### SUMMARY OF INVENTION

### Technical Problem

However, the technique of PTL 1 can conduct fraud detection in the computer operation of a user, but is not improper for the fraud detection in the large-scaled industrial system such as the power system.

Because the industrial system is a large-scaled and complicated system, the control instructions given to the control device are various depending on a status of the system. This makes it difficult for the control device to detect whether the control instruction is fraudulent, or not, according to the tendency of the control instruction given in the past with high precision.

An object of the present invention is to provide a technique of calculating the reliability of the control instruction with high precision.

### Solution to Problem

According to an aspect of the present invention, there is provided a reliability calculation device that calculates reliability of a control instruction given to a control device which executes a control according to the control instruction, including: an instruction acquisition unit that acquires the control instruction to the control device; an information acquisition unit that acquires relevant information relevant to the control which is executed by the control device; and a reliability calculation unit that calculates the reliability of a target control instruction which is the control instruction to be calculated in reliability, on the basis of the relevant information relevant to the control of the target control instruction, which is acquired by the information acquisition unit in association with the target control instruction to be acquired by the instruction acquisition unit, and the target control instruction.

### Advantageous Effects of Invention

According to the present invention, the reliability can be calculated with high precision.

### BRIEF DESCRIPTION OF DRAWINGS

FIG. 1 is a block diagram of a reliability calculation device according to this embodiment.

FIG. 2 is an overall configuration diagram of a control system according to this embodiment.

FIG. 3 is a configuration diagram of a measured value history DB 440.

FIG. 4 is a configuration diagram of a control instruction value history DB 450.

FIG. 5 is a configuration diagram of a reliability calculation setting DB 460.

FIG. 6 is a configuration diagram of a reliability reduction rate DB 470.

FIG. 7 is a configuration diagram of a reliability threshold value DB 480.

FIG. 8 is a flowchart illustrating a reliability calculation process by a reliability calculation program 410;

FIG. 9 is a flowchart illustrating a response operation determination process by a response operation determination program 420.

FIG. 10 is a diagram illustrating a power system according to an embodiment of the present invention.

### DESCRIPTION OF EMBODIMENTS

A basic embodiment of the present invention will be described with reference to the drawings.

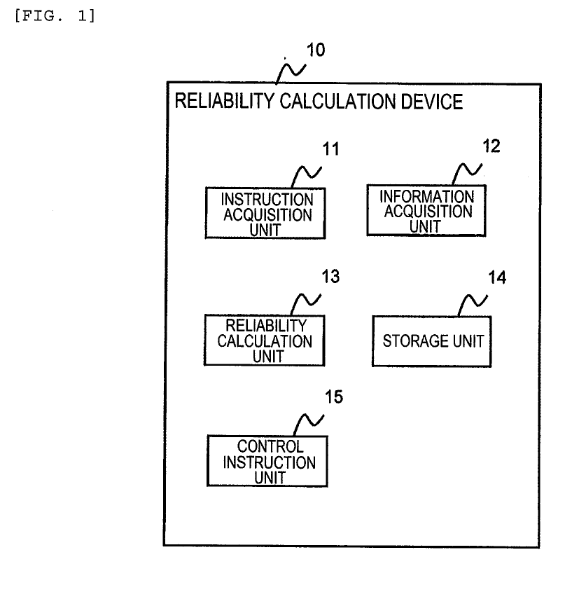

FIG. 1 is a block diagram of a reliability calculation device according to this embodiment. In a control system having plural control devices that execute given control instructions, a reliability calculation device 10 according to this embodiment calculates the reliability of a control instruction to be given to the respective control devices. Also, the calculated reliability is used for determination of whether the control instruction may be given to the control device as it is, or not.

Referring to FIG. 1, the reliability calculation device 10 has an instruction acquisition unit 11, an information acquisition unit 12, a reliability calculation unit 13, a storage unit 14, and a control instruction unit 15.

The instruction acquisition unit 11 acquires a control instruction to be given to the control device. The instruction acquisition unit 11 receives the control instruction from a control instruction transmission device for transmitting the control instruction to the respective control devices.

The information acquisition unit 12 acquires relevant information relevant to a control to be executed by the control device according to the control instruction from various devices within the control system.

As an example, the relevant information is a relevant control instruction that is a control instruction to be calculated in reliability to the relevant control device which is acquired at the same time when a target control instruction is acquired by the instruction acquisition unit 11. The relevant control device is another control device relevant to the target control device that executes the control according to the target control instruction. In the present specification, “at the same time” does not mean the exact same time”. The same is applied to the following matters. For example, since the control instruction is relevant to the target control instruction, the control instruction acquired around the same time such as within a given time before and after an acquisition time of the target control instruction is included in the relevant control instruction.

The control device that geographically falls within a given range from the target control device may be set as the relevant control device of the target control device. Alternatively, a control device of the same type as that of the target control device may be set as the relevant control device. Alternatively, a control device similar in tendency of the control to the target control device may be set as the relevant control device. In the industrial system such as the power system, the control devices that geographically fall within the given range, and are of the same type such as SVRs (step voltage regulators) of the same power system may be similar in the tendency of the control, or correlated with each other.

Alternatively, as another example, the relevant information may be a measured value related to a state of the target control device which is acquired by the information acquisition unit 12 from a measurement device that measures a state of the control system including the target control device while the target control instruction is acquired by the instruction acquisition unit 11. For example, a current value or a power value which is an input or an output of the target control device, or a measured value obtained by measuring a state value of a peripheral device may be set as the relevant information.

The reliability calculation unit 13 calculates the reliability of the target control instruction which is the control instruction to be calculated in reliability, on the basis of the relevant information relevant to the control of the target control instruction, which, is acquired by information acquisition unit 12 while the target control instruction is acquired by the instruction acquisition unit 11, and the target control instruction.

Also, the storage unit 14 stores history information on one or both of the control instruction acquired by the instruction acquisition unit 11, and the relevant information acquired by the information acquisition unit 12. For example, information acquired by the instruction acquisition unit 11 and the information acquisition unit 12 is sequentially stored in the storage unit 14. The reliability calculation unit 13 may calculate the reliability on the basis of the history information in addition to the target control instruction.

According to this embodiment, the reliability of the current control instruction is calculated on the basis of the relevant information relative to the control to the target control device, such as not only the current and past control instructions to the target control device, but also the instruction to the relevant control device, and the measured value of the state of the target control device. Therefore, in the system where various statuses are mutually related to each other, the reliability can be calculated with high precision.

The control instruction unit 15 subjects the target control device to the control according to the target control instruction if the reliability of the target control instruction calculated by the reliability calculation unit 13 is equal to or higher than a given threshold value.

Also, as an example, the control instruction unit 15 may give the control instruction determined to be equal to or higher in the previous reliability than the threshold value to the target control device, instead of the target control instruction if the reliability of the target control instruction is lower than the threshold value. Alternatively, the control instruction unit 15 may give a control instruction for stopping the control related to the target control instruction to the target control device if the reliability of the target control instruction is lower than the threshold value. Alternatively, the control instruction unit 15 may discard the target control instruction, and notify a central management device that manages the control system of an error if the reliability of the target control instruction is lower than the threshold value. Further, the control instruction unit 15 may suspend the target control instruction to be given to the target control device, and give the target control instruction to the control device when a given number of control instructions of the same contents as those of the target control instruction are continued, if the reliability of the target control instruction is lower than the threshold value.

Subsequently, a more specific embodiment will be described.

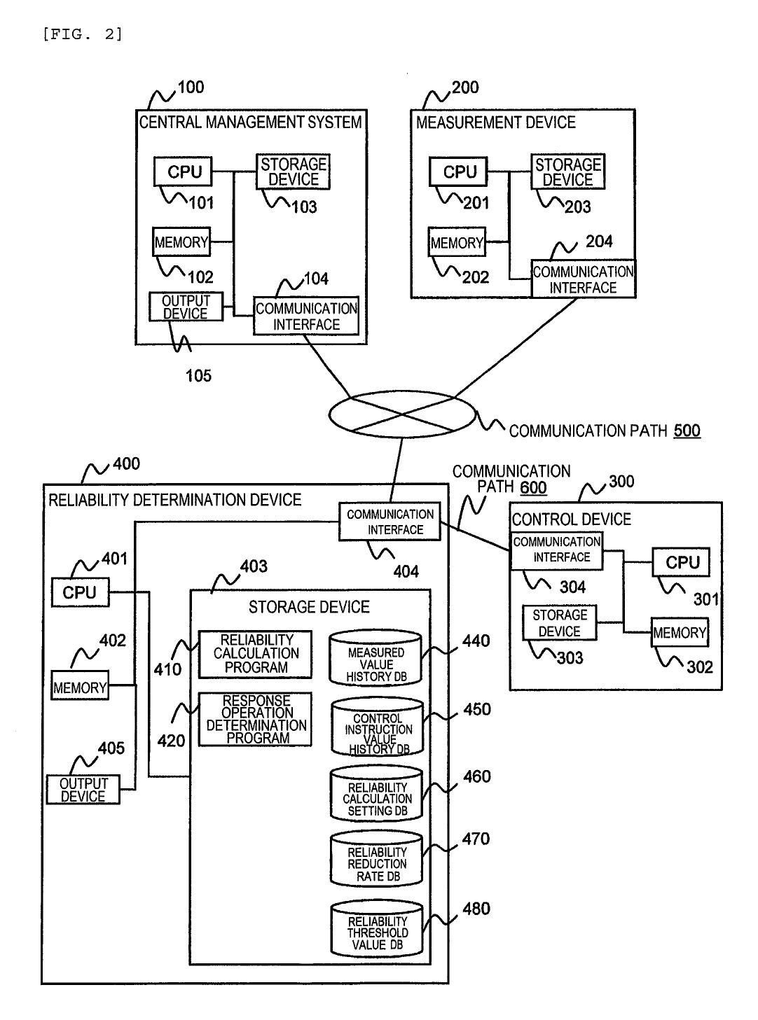

FIG. 2 is an overall configuration diagram of a control system according to this embodiment. The control system includes a reliability determination device 400, a control device 300, a central management system 100, a measurement device 200, a communication path 500, and a communication path 600. In this example, only one control device 300 is illustrated. However, it is actually general that plural control devices 300 are present.

The communication path 500 mutually connects the central management system 100, the measurement device 200, and the reliability determination device 400 to each other. The communication path 500 is a standard communication path such as a wired communication or a wireless communication.

The communication path 600 is a dedicated line different from the communication path 500 that connects the reliability determination device 400 and the control device 300 to each other. The communication path 600 is a standard communication path such as a wired communication or a wireless communication.

The central management system 100 calculates a control amount to be output by the control device 300, superimposes the control amount on the control instruction, and gives the control amount to the control device 300 through the communication path 500.

The central management system 100 includes at least a CPU (central processing unit) 101, a memory 102, a storage device 103, a communication interface 104, and an output device 105.

The output device 105 is configured by, for example, a display device or a light, and displays an output of a program running on the central management system, and outputs of the respective devices which are acquired through the communication path 500.

The communication interface 104 is an interface such as a wired LAN (local area network) card or a wireless LAN card, and communicates with the measurement device 200 or the reliability determination device 400 through the communication path 500.

The storage device 103 is a device that stores a program or data such as a hard disk or a flash memory.

Subsequently, the measurement device 200 is a device for measuring a state value such as a temperature sensor or a current sensor, and transmits the acquired measured value to another device through the communication path 500. The measurement device 200 includes at least a CPU 201, a memory 202, a storage device 203, and a communication interface 204.

The communication interface 204 is an interface such as a wired LAN card or a wireless LAN card, and communicates with the central management system 100 or the reliability determination device 400 through the communication path 500.

The storage device 203 is a device that stores a program or data such as a hard disk or a flash memory.

The control device 300 is a device that executes control operation on the basis of the control instruction of the central management system 100. The control device 300 includes at least a CPU 301, a memory 302, a storage device 303, and a communication interface 304.

The communication interface 304 is an interface such as a wired LAN card or a wireless LAN card, and communicates with the reliability determination device 400 through the communication path 600.

The storage device 303 is a device that stores a program or data such as a hard disk or a flash memory.

The reliability determination device 400 is a device that determines the reliability of the control instruction given to the control device 300 from the central management system 100, and determines the control operation (response operation) to be actually executed by the control device 300 according to the control instruction. The reliability determination device 400 is a device corresponding to the reliability calculation device 10 in FIG. 1, and further includes a function of determining the reliability of the control instruction. The reliability determination device 400 includes at least a CPU 401, a memory 402, a storage device 403, a communication interface 404, and an output device 405.

The communication interface 404 is an interface such as a wired LAN card or a wireless LAN card, and communicates with the central management system 100 and the measurement device 200 through the communication path 500, and also through the control device 300 and the communication path 600.

The output device 405 is a device configured by a display device that displays a text or an image, or a light that turns on or off. The output device 405 presents an output value such as the reliability calculated by a reliability calculation program 410 or response operation determined by a response operation determination program 420 to the user under control from a CPU 401. Also, the output value may be transmitted to the central management system 100 through the communication path 500, and output to the output device 105 of the central management system 100.

With the above configuration, a manager confirms the display of the output device 105 or the output device 405 so as to recognize how the control device 300 operates according to the control instruction of the central management system 100.

The storage device 403 is a device that stores a program or data such as a hard disk or a flash memory. The programs stored in the storage device 403 include at least the reliability calculation program 410 and the response operation determination program 420. Also, the data stored in the storage device 403 includes at least a measured value history DB 440, a control instruction value history DB 450, a reliability calculation setting DB 460, a reliability reduction rate DB 470, and a reliability threshold value DB 480.

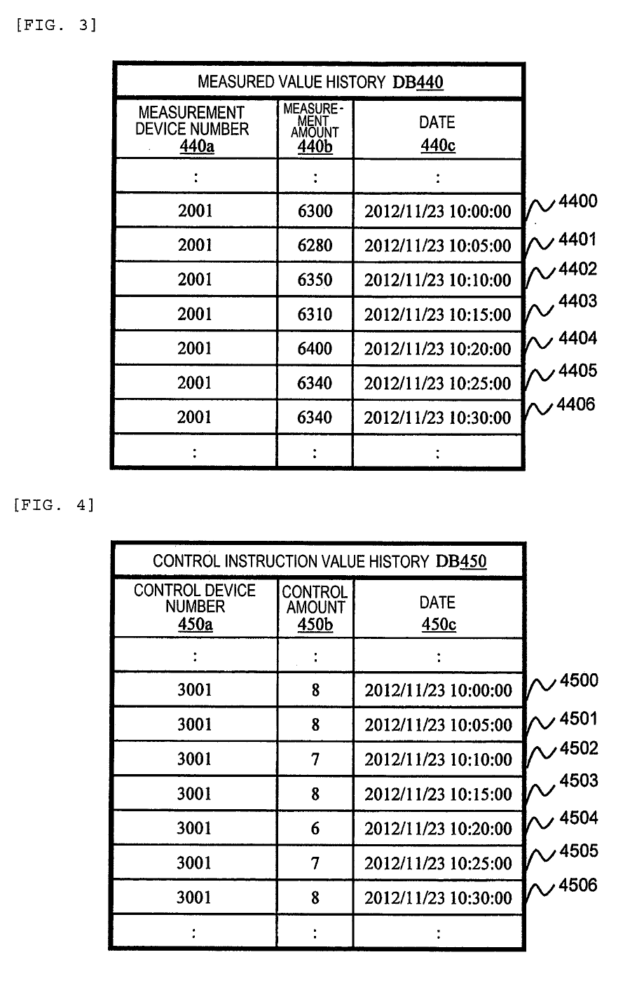

The measured value history DB 440 is a database for managing the data measured by the measurement device 200. The data of the measured value history DB 440 is data whose reliability is secured. For example, the data measured by the measurement device 200 that is in an abnormal state is not stored in the measured value history DB 440, or recorded in distinction from data in a normal state. A configuration of the measured value history DB 440 will be described later with reference to FIG. 3.

The control instruction value history DB 450 is a database for managing data of the control instruction transmitted from the central management system 100.

The data of the control instruction value history DB 450 is data whose reliability is secured. For example, the control instruction that has not been executed for the reason that the reliability is low is not stored in the measured value history DB 440, or recorded in distinction from the control instruction normally executed. A configuration of the control instruction value history DB 450 will be described later with reference to FIG. 4.

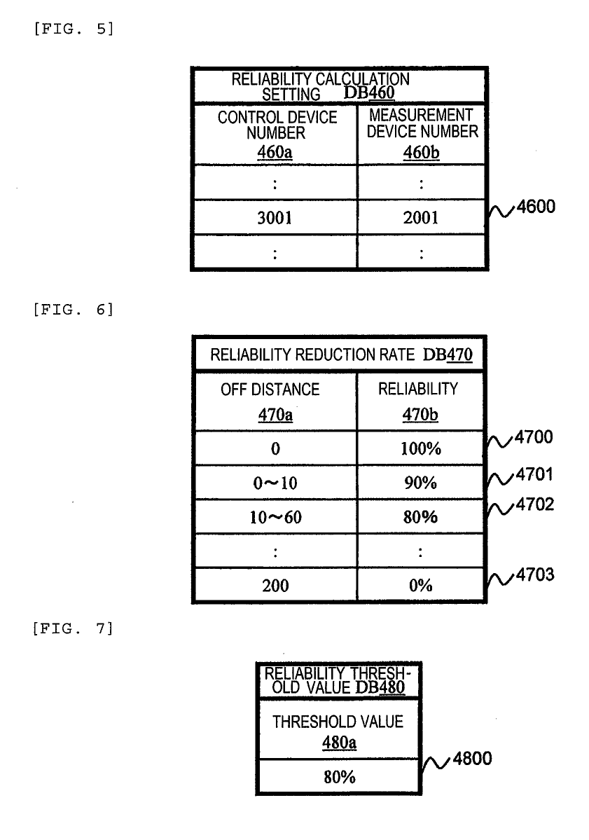

The reliability calculation setting DB 460 is a database in which setting data used for calculation of the reliability is stored. The reliability calculation setting DB 460 stores the setting data for managing a relationship between a control device number that uniquely specifies the control device 300, and a measurement device number that uniquely specifies the measurement device 200. A configuration of the reliability calculation setting DB 460 will be described later with reference to FIG. 5.

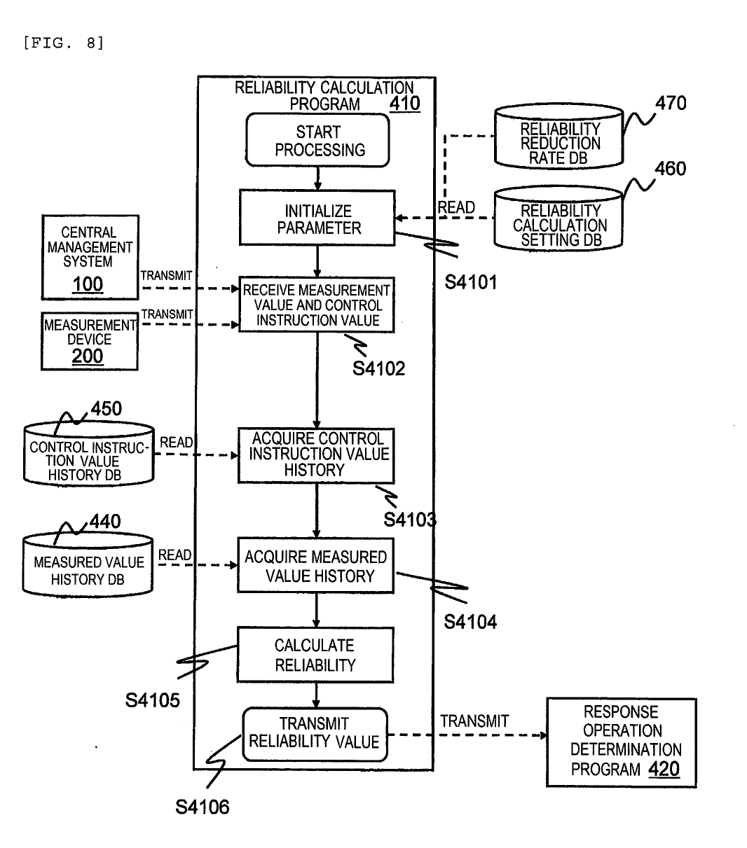

The reliability reduction rate DB 470 is a database in which the setting data used for calculation of the reliability is stored. The reliability reduction rate DB 470 stores the setting data for managing a relationship a relationship between an off condition and the reliability from the past control instruction value therein. A configuration of the reliability reduction rate DB 470 will be described later with reference to FIG. 6.

The reliability threshold value DB 480 is a database in which the setting data of a threshold value of the reliability calculated by the reliability determination device 400 is stored. The response operation to be actually executed according to the control instruction from the central management system 100 is determined on the basis of the threshold value. A configuration of the reliability threshold value DB 480 will be described later with reference to FIG. 7.

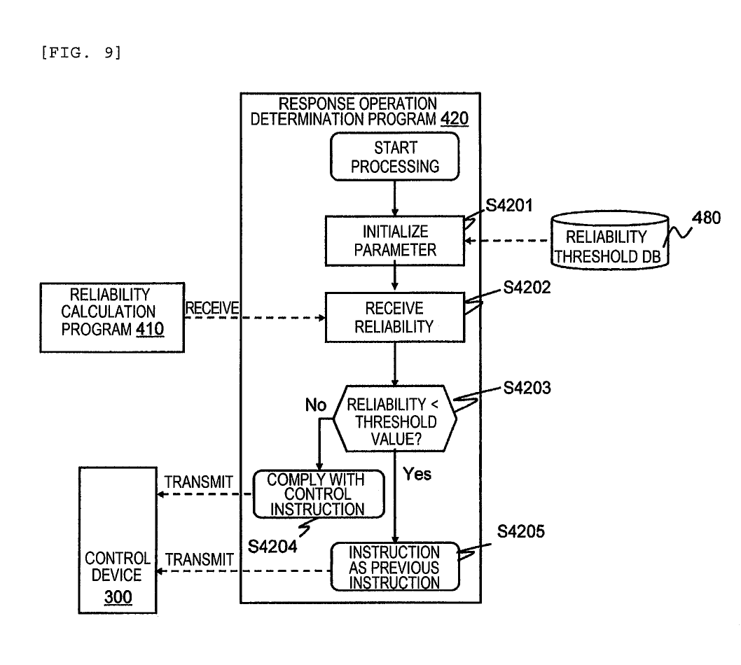

The reliability calculation program 410 is a program to be executed by the CPU 401, and allows the CPU 401 to execute a process of calculating the reliability. The processing of the reliability calculation program 410 is a process of receiving the control device number and the control value to the device from the central management system 100, receiving the measurement device number and the measured value of the device from the measurement device 200, calculating the reliability on the basis of those information, and transmitting a value of the calculated reliability to the response operation determination program 420. A reliability calculation process flow by the reliability calculation program 410 will be described later with reference to FIG. 8.

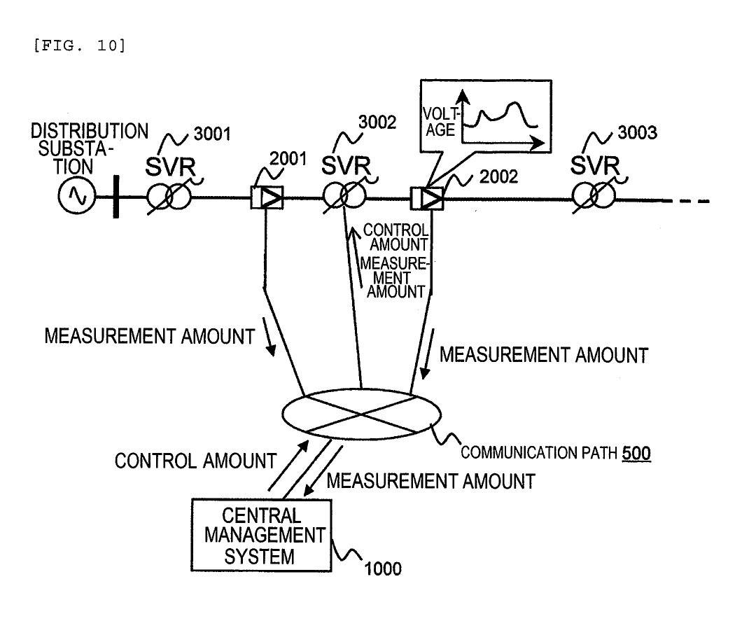

The response operation determination program 420 is a program to be executed by the CPU 401, and allows the CPU 401 to execute a process of determining the response operation on the basis of the reliability. The processing of the response operation determination program 420 is a process of receiving the control device number, the control amount, and the reliability from the reliability calculation program 410, determining the response operation to the control instruction of the central management system 100 on the basis of those information, and transmitting the determined response operation to the control device 300. A response operation determination process flow by the response operation determination program 420 will be described later with reference to FIG. 9.

Those programs stored in the storage device 403 are read in the memory 402, and executed by the CPU 401.

FIG. 3 is a configuration diagram of the measured value history DB 440.

The measured value history DB 440 includes at least a measurement device number 440a, a measurement amount (measured value) 440b, and date 440c as a field of record.

In the measurement device number 440a is set a number that uniquely specifies the measurement device 200.

In the measurement amount 440b is recorded a measured value acquired by the measurement device 200 corresponding to the set measurement device number 440a.

In the date 440c is set date at which the measured value is acquired by the measurement device 200.

FIG. 4 is a configuration diagram of the control instruction value history DB 450.

The control instruction value history DB 450 includes at least a control device number 450a, a control amount (control value) 450b, and a date 450c as the field of record.

In the control device number 450a is set a number that uniquely specifies the control device 300.

In the control amount 450b is recorded a control instruction value generated by the central management system 100 to the control device 300 of the set control device number.

In the date 450c is recorded date in which the data is instructed from the central management system 100.

FIG. 5 is a configuration diagram of the reliability calculation setting DB 460.

The reliability calculation setting DB 460 includes at least a control device number 460a, and a measurement device number 460b as the field of record.

In the control device number 460a is set a number that uniquely specifies the control device 300.

In the measurement device number 460b is set a number that uniquely specifies the measurement device 200 corresponding to the control device 300 of the set control device number. The number is used in calculating the reliability.

FIG. 6 is a configuration diagram of the reliability reduction rate DB 470.

The reliability reduction rate DB 470 includes at least an off distance 470a and reliability 470b as the field of record.

In the off distance 470a is set a value of the off distance between the received data and the history.

In the reliability 470b is set a value of the reliability corresponding to the set off distance. The value is set in calculating the reliability.

FIG. 7 is a configuration diagram of the reliability threshold value DB 480.

The reliability threshold value DB 480 includes at least a threshold value 480a as the field of record.

A threshold value set in the threshold value 480a is used in determining response operation to the control instruction of the central management system 100 on the basis of the reliability calculated by the reliability determination device 400. For example, if the reliability of the control instruction is equal to or higher than a threshold value, the control instruction is given to the control device 300 as it is, and the control device 300 executes the operation corresponding to the control instruction.

FIG. 8 is a flowchart illustrating a reliability calculation process by the reliability calculation program 410.

According to the flow, the CPU 401 receives the control device number and the control amount for the device from the central management system 100, and the measurement device number and the measurement amount of the device from the measurement device 200, calculates the reliability with the use of those information, the data managed by the measured value history DB 440, and the data managed by the control instruction value history DB 450, and transmits a numeric value of the calculated reliability to the response operation determination program 420.

Referring to FIG. 8, the CPU 401 that first executes the reliability calculation program 410 acquires various set data necessary for calculating the reliability at the time of starting the program, and writes the set data in the memory 402 (S4101). Specifically, the CPU 401 acquires the control device number, and the measurement device number (hereinafter called “measurement device number for reliability calculation”) to be used in calculating the reliability of the control device 300 indicated by the control device number, from the reliability calculation setting DB 460. Also, the CPU 401 acquires the off distance, and the reliability corresponding to the off distance from the reliability reduction rate DB 470. Then, the CPU 401 writes those acquired information in the memory 402.

Then, the CPU 401 receives the control device number and the control amount for the device from the central management system 100, and the measurement device number and the measurement amount for the device from the measurement device 200 (S4102). The CPU 401 starts a process of calculating the reliability subsequent to the reception upon receiving those information.

As a process of calculating the reliability, the CPU 401 acquires records with the control device number and the control amount acquired in Step S4101 as search keys from the control instruction value history DB 450 (S4103). For example, when the combination of data (control device number, control amount, date) received in Step S4102 is (3001, 8, 2012/11/24 10:00:00), and the combination of (measurement device number, measurement amount, date) is (2001, 6600, 2012/11/24 10:00:00), the CPU 401 acquires four records of 4500, 4501, 4503, and 4506 in FIG. 4.

Then, the CPU 401 acquires the records with the measurement device number for the reliability calculation corresponding to the control device number received in Step S4102, and the date of the records acquired in S4103 as search keys from the measured value history DB 440 (S4104). For example, when the combination of data (control device number, control amount, date) received in Step S4102 is (3001, 8, 2012/11/24 10:00:00), and the combination of (measurement device number, measurement amount, date) is (2001, 6600, 2012/11/24 10:00:00), the CPU 401 acquires the measurement device number “2001” on the basis of the record of 4600 in FIG. 5. Also, the CPU 401 acquires date “2012/11/23 10:00:00”, “2013/11/24 10:05:00”, “2012/11/24 10:15:00”, and “2012/11/24 10:30:00” on the basis of those four records of 4500, 4501, 4503, and 4506 in FIG. 4. Further, the CPU 401 acquires four records of 4400, 4401, 4403, and 4406 in FIG. 3 with the acquired number as a search key.

Then, the CPU 401 calculates the reliability of the control amount received in Step S4102 with the control amount and the measurement amount received in Step S4102, the control instruction value history acquired in Step S4103, and the measured value history acquired in Step S4104 (S4105). Specifically, the CPU 401 sets the reliability as “100%” if the measured value of data received from the measurement device 200 in Step S4102 is in an interval between a maximum value and a minimum value of the measurement amount in the record acquired in Step S4104 with respect to the measurement device number for the reliability calculation corresponding to the control device number received in Step S4102. Also, the CPU 401 calculates the reliability on the basis of the off distance from the interval according to a reliability reduction rate acquired in Step S4101 if the measured value is out of the interval between the maximum value and the minimum value. For example, when the combination of data (control device number, control amount, date) received in Step S4102 is (3001, 8, 2012/11/24 10:00:00), and the combination of (measurement device number, measurement amount, date) is (2001, 6600, 2012/11/24 10:00:00), the measured value “6600” of data received in Step S4102 is out of an interval between the maximum value “6340” and the minimum value “6280” of the measurement amount in the record acquired in Step S4104 with respect to the measurement device number “2001” for the reliability calculation corresponding to the control device number “3001” received in Step S4102. Since the off distance is 6600−6340=260, the reliability is calculated as “0%” from the record 4703 in FIG. 6.

Then, the CPU 401 transfers the control device number and the control amount received in Step S4102, and the reliability created in Step S4105 to the process of the response operation determination program 420 from the process of the reliability calculation program (S4106). For example, when the combination of data (control device number, control amount, date) received in Step S4102 is (3001, 8, 2012/11/24 10:00:00), and the combination of (measurement device number, measurement amount, date) is (2001, 6600, 2012/11/24 10:00:00), the CPU 401 calculates the reliability as “0%” in Step S4105, and transmits data that the combination of (control device number, control amount, reliability) is (3001, 8, 0%).

FIG. 9 is a flowchart illustrating a response operation determination process by the response operation determination program 420.

The CPU 401 that executes the processing by the response operation determination program 420 according to the flow receives the control device number, the control amount, and the reliability from the processing of the reliability calculation program 410, determines the response operation to the control instruction of the central management system 100 based on the values, and transmits the control instruction for instructing the determined response operation to the control device 300.

Referring to FIG. 9, if the CPU 401 that first executes the response operation determination program 420 acquires the threshold value used in determining the response operation to the control instruction of the central management system 100, from the reliability threshold value DB 480 at the time of starting the program, and reads the threshold value in the memory 402 (S4201).

The process for determining the response operation starts at a moment when the response operation determination program 420 receives the control device number, the control amount, and the reliability from the reliability calculation program 410 (S4202).

As the process for determining the response operation, the CPU 401 compares the threshold value acquired in Step S4201 with the reliability acquired in Step S4202, proceeds to Step S4204 if the reliability is equal to or higher than the threshold value, and proceeds to Step S4205 if the reliability is lower than the threshold value (S4203). For example, when the combination of data (control device number, control amount, reliability) received in Step S4202 is (3001, 8, 0%), since the reliability is smaller than the threshold value “80%” acquired in Step S4201, the flow proceeds to the processing of Step S4205.

In Step S4204, the CPU 401 transmits a control value to the control device 300 which is received in Step S4202 to the control device 300 corresponding to the control device number received in the same step.

On the other hand, in Step S4205, the CPU 401 transmits a normal control value determined in a previous response operation determination process in the control device 300 to the control device 300 corresponding to the control device number received in Step S4202.

The embodiment of the present invention has been described specifically above. However, the present invention is not limited to this configuration, but can be variously changed without departing from the spirit of the invention.

For example, in the system configuration of FIG. 2, the reliability determination device 400 and the control device 300 are divided into physical different devices. However, a physically one device may function as both of the function of the control device 300 and the function of the reliability determination device 400. More specifically, the function of the reliability determination device 400 may be incorporated into the control device 300.

Also, in this embodiment, in order to determine the reliability of the control instruction to the control device 300, the reliability determination device 400 and the control device 300 are connected to each other by the communication path 600 which is a dedicated line higher in reliability. However, in order to determine the likelihood of the control instruction generated by the central management system 100, the reliability determination device 400 and the central management system 100 may be connected to each other by the communication path 600.

Also, in this embodiment, the measured value history DB 440 and the control instruction value history DB 450 manage only the data created when the reliability is ensured. However, the present invention is not limited to this configuration. As another example, if the reliability calculated by the reliability calculation program 410 is larger than a given specified value, the reliability determination device 400 may register the data received from the central management system 100 or the measurement device 200 in the measured value history DB 440 or the control instruction value history DB 450 as the history.

Also, in this embodiment, in the reliability calculation setting DB 460, the control device number and the measurement device number correspond to 1:1. However, as another example, plural measurement device numbers may be associated with one control device number.

Also, in this embodiment, in Step S4103 and Step S4104, a history that matches the control value is also acquired in addition to the control device number acquired in Step S4102, and the reliability is calculated on the basis of those information. However, as another example, a history that matches the control device number acquired in Step S4102 is acquired, and a regression formula that approximates a relationship between the control amount and the measurement value on the basis of the history may be obtained to calculate the reliability with the use of the regression formula.

Also, in this embodiment, the reliability is calculated on the basis of the respective data acquired from Step S4102, Step S4103, and Step S4104. However, as another example, in Step S4102, the reliability may be calculated on the basis of only the control device number and the control amount for the control device 300 which are received from the central management system 100, and the measurement device number and the measured value from the measurement device 200 which are received from the measurement device 200.

FIG. 10 is a diagram illustrating a power system according to an embodiment of the present invention. For example, in the power system of FIG. 10, the reliability of the control instruction to an SVR 3002 which is the control device 300 may be calculated with the use of a tap value which is a control value to the control device 300, and a voltage measurement value which is a measurement device 2001 on a distribution substation side with respect to the control device 300. Specifically, when a transformation ratio becomes smaller as the tap value is larger, if a value obtained by multiplying the tap value by the voltage measurement value falls within a given voltage specified range, the reliability is set “100%”, and if the value falls outside the voltage specified range, the reliability may be set to a value corresponding to the off distance from the range. A relationship between the tap value and the transformation ratio is set as an example, as follows.

Tap Value=1: transformation ratio=6930/6600(=1.05)

Tap Value=2: transformation ratio=6848/6600(=1.03)

Tap Value=3: transformation ratio=6763/6600(=1.02)

Also, in this embodiment, the reliability is calculated on the basis of the respective data acquired in Step S4102, Step S4103, and S4104. However, as another example, the reliability determination device 400 may calculate the reliability with the use of a control value to a first control device (target control device) 300 that is a target of the control instruction for calculating the reliability received from the central management system 100 in Step S4102, and a control value to a second control device 300 adjacent to the first control device 300.

For example, in the power system of FIG. 10, the reliability of the control instruction to an SVR 3002 which is the first control device 300 may be calculated with the use of a tap value which is the control value to the control device 300, and a tap value that is the control value to an SVR 3001 or an SVR 3003 which is the second control device 300 arranged before or after the control device 300. Specifically, if the tap value of the control instruction to the SVR 3002 is away from the tap value of the control instruction to the SVR 3001 or SVR 3003 by a specified value or more, the reliability of the control instruction may be reduced.

Also, in this embodiment, the reliability is calculated on the basis of the respective data acquired in Step S4102, Step S4103, and Step S4104. However, as another example, the reliability may be calculated with the use of the control value to the first control device 300, the control value to the second control device 300 adjacent to the first control device 300, and the histories of the control values to the first and second control devices 300 which are received from the central management system 100 in Step S4102.

For example, in the power system of FIG. 10, the reliability of the control instruction to the SVR 3002 which is the first control device 300 may be calculated with the use of the tap value which is the control value to the control device 300, the tap value which is the control value to the SVR 3001 or the SVR 3003 which is the second control device 300 arranged before or after the control device 300, the history of the control value to the SVR 3002, and the history of the control value to the SVR 3001 or the SVR 3003. Specifically, the combination of the tap value to the SVR 3002 and the tap value to the SVR 3001 or the SVR 3003 is absent in the history, the reliability decreases.

Also, in this embodiment, in Step S4205, the reliability determination device 400 transmits the control instruction of the same control operation as the response operation that has been executed previously to the control device 300 without complying with the control instruction received from the central management system 100. However, as another example, if the control device 300 is a device that continues to output the control amount currently output until the control device 300 receives a new control instruction, when the reliability determination device 400 allows the control device 300 to continue the control operation until then without complying with the control instruction received from the central management system 100, the reliability determination device 400 may not transmit the control instruction to the control device 300.

Also, in this embodiment, in Step S4205, the same control operation as the previous control operation is conducted without complying with the control instruction. Alternatively, an instruction for stopping the control output may be transmitted to the control device 300.

Also, in this embodiment, in Step S4205, the same control operation as the previous control operation is conducted without complying with the control instruction. Further, a fact that does not comply with the control instruction may be returned as an error to the central management system 100 or another control device 300.

Also, in this embodiment, in Step S4205, the same control operation as the previous control operation is continued without complying with the control instruction. However, as another example, even if the reliability of the control instruction from the central management system 100 is lower than the threshold value, if the control instructions for instructing the same control operation from the central management system 100 are continuously received by a given number of time or more, the control instruction for executing the control operation according to the control instruction may be transmitted to the control device 300.

Also, in this embodiment, in Step S4205, the control instruction for instructing the same control operation as the previous control operation is transmitted to the control device 300 without complying with the control instruction. However, as another example, if the reliability of the control instruction from the central management system 100 is lower than the threshold value, the control operation according to the control instruction in another control device 300 such as the control device 300 adjacent to the target control device 300 may be confirmed, and the control operation of another control device 300 may be used in determining the control operation to be instructed to the target control device 300.

Also, in this embodiment, in Step S4205 the control operation under execution is continued in the control device 300 without complying with the control instruction. Also, as a modification, various methods for determining the control operation are exemplified. However, as still another example, the above-mentioned various methods may be combined together to determine the control operation to be executed by the control device 300.

### REFERENCE SIGNS LIST

10 . . . reliability calculation device, 100 . . . central management system, 101 . . . CPU, 102 . . . memory, 103 . . . storage device, 104 . . . communication interface, 105 . . . output device, 11 . . . instruction acquisition unit, 12 . . . information acquisition unit, 13 . . . reliability calculation unit, 14 . . . storage unit, 15 . . . control instruction unit, 200 . . . measurement device, 201 . . . CPU, 202 . . . memory, 203 . . . storage device, 204 . . . communication interface, 300 . . . control device, 301 . . . CPU, 302 . . . memory, 303 . . . storage device, 304 . . . communication interface, 400 . . . reliability determination device, 401 . . . CPU, 402 . . . memory, 403 . . . storage device, 404 . . . communication interface, 405 . . . output device, 410 . . . reliability calculation program, 420 . . . response operation determination program, 440 . . . measured value history DB, 450 . . . control instruction value history DB, 460 . . . reliability calculation setting DB, 470 . . . reliability reduction rate DB, 480 . . . reliability threshold value DB, 500 . . . communication path, and 600 . . . communication path.

1.-2. (canceled)

3. A reliability calculation device that calculates reliability of a control instruction given to a control device which executes a control according to the control instruction, comprising:
an instruction acquisition unit that acquires the control instruction to the control device;
an information acquisition unit that acquires relevant information relevant to the control which is executed by the control device; and
a reliability calculation unit that calculates the reliability of a target control instruction which is the control instruction to be calculated in reliability, on the basis of the relevant information relevant to the control of the target control instruction, which is acquired by the information acquisition unit in association with the target control instruction to be acquired by the instruction acquisition unit, and the target control instruction,
wherein the control device is a control device for a power system, and
wherein the relevant information is a relevant control instruction that is a control instruction to a relevant control device which is another control device adjacent to the target control device, which is acquired while the target control instruction is acquired by the instruction acquisition unit.

4. The reliability calculation device according to claim 3,
wherein the relevant control device is a control device that geographically falls within a given range from the target control device.

5. The reliability calculation device according to claim 3,
wherein the relevant control device is a control device of the same type as that of the target control device.

6. The reliability calculation device according to claim 3,
wherein the relevant control device is a control device that is similar in a tendency of the control to the target control device.

7. (canceled)

8. A reliability calculation device that calculates reliability of a control instruction given to a control device which executes a control according to the control instruction, comprising:
an instruction acquisition unit that acquires the control instruction to the control device;
an information acquisition unit that acquires relevant information relevant to the control which is executed by the control device;
a reliability calculation unit that calculates the reliability of a target control instruction which is the control instruction to be calculated in reliability, on the basis of the relevant information relevant to the control of the target control instruction, which is acquired by the information acquisition unit in association with the target control instruction to be acquired by the instruction acquisition unit, and the target control instruction; and
a control instruction unit that subjects the control device to the control according to the target control instruction if the reliability of the target control instruction calculated by the reliability calculation unit is equal to or higher than a given threshold value, and determines control operation to be instructed to the control device with the use of a control instruction in another control device adjacent to the control device if the reliability of the target control instruction is lower than the threshold value.

9.-11. (canceled)

12. A reliability calculation device that calculates reliability of a control instruction given to a control device which executes a control according to the control instruction, comprising:
an instruction acquisition unit that acquires the control instruction to the control device;
an information acquisition unit that acquires relevant information relevant to the control which is executed by the control device;
a reliability calculation unit that calculates the reliability of a target control instruction which is the control instruction to be calculated in reliability, on the basis of the relevant information relevant to the control of the target control instruction, which is acquired by the information acquisition unit in association with the target control instruction to be acquired by the instruction acquisition unit, and the target control instruction; and
a control instruction unit that subjects the control device to the control according to the target control instruction if the reliability of the target control instruction calculated by the reliability calculation unit is equal to or higher than a given threshold value,
wherein the control instruction unit suspends the target control instruction to be given to the control device if the reliability of the target control instruction is lower than the threshold value, and gives the target control instruction to the control device when a given number of control instructions of the same contents as those of the target control instruction are continued.

13. A reliability calculation method for calculating reliability of a control instruction given to a control device which executes a control according to the control instruction, comprising the steps of:
acquiring the control instruction to the control device by an instruction acquisition unit;
acquiring relevant information relevant to the control which is executed by the control device by an information acquisition unit; and
calculating the reliability of a target control instruction which is the control instruction to be calculated in reliability, on the basis of the relevant information relevant to the control of the target control instruction, which is acquired by the information acquisition unit in association with the target control instruction to be acquired by the instruction acquisition unit, and the target control instruction, by a reliability calculation unit,
wherein the relevant information is a measured value related to a state of the target control device which is acquired by the information acquisition unit from a measurement device that measures a state of the control system including the target control device which executes the control according to the target control instruction while the largest control instruction is acquired by the instruction acquisition unit, and
wherein the reliability calculation unit calculates the reliability on the basis of an off distance of the measured value from an interval between a maximum value and a minimum value of the history.

14. A reliability calculation method for calculating reliability of a control instruction given to a control device which executes a control according to the control instruction, comprising the steps of:
acquiring the control instruction to the control device by an instruction acquisition unit;
acquiring relevant information relevant to the control which is executed by the control device by an information acquisition unit; and
calculating the reliability of a target control instruction which is the control instruction to be calculated in reliability, on the basis of the relevant information relevant to the control of the target control instruction, which is acquired by the information acquisition unit in association with the target control instruction to be acquired by the instruction acquisition unit, and the target control instruction, by a reliability calculation unit,
wherein the target control instruction includes a control amount,
wherein the relevant information is a measured value related to a state of the target control device which is acquired by the information acquisition unit from a measurement device that measures a state of the control system including the target control device which executes the control according to the target control instruction while the target control instruction is acquired by the instruction acquisition unit, and
wherein the reliability calculation unit obtains a regression expression that approximates a relationship between the control amount and the measurement value in the history, and calculates the reliability with the use of the regression expression for the control amount of the target control instruction and the measured value related to the state of the target control device.
